(19) United States
(12) Patent Application Publication
(10) Pub. No.: US 2010/0209165 A1
(43) Pub. Date: Aug. 19, 2010

(54) RECORDING ENGINE THERMAL COMPENSATOR

(76) Inventors: Peter J. Hawes, Burnaby (CA); Ali Faraz, Port Moody (CA)

Correspondence Address: Amelia A. Buharin;Patent Legal Staff, Eastman Kodak Company, 343 State Street, Rochester, NY, 14650-2201, US

(21) Appl. No.: 12/372,066

(22) Filed: Feb. 17, 2009

(51) Int. Cl. B41J 11/20

(52) U.S. Cl. 400/53

(57) ABSTRACT

A recording apparatus includes a media support adapted to receive recording media. One or more guide members are attached to the support and extend along a first direction substantially perpendicular to a first neutral axis and a second neutral axis associated with an assemblage comprising at least the support and the guide members. A carriage is adapted to move along the guide members and operable for moving a recording head along a path relative to the media support while forming an image on the recording media. One or more thermal compensation members is fixedly attached to the support to reduce distortions of the assemblage about both the first neutral axis. The second neutral axis, the distortions arise from a difference in thermal expansion between the each of the one or more guide members and the support.

### FIELD OF THE INVENTION

The invention relates to recording systems for forming images on recording media. The invention may be applied to computer-to-plate systems, for example.

### BACKGROUND OF THE INVENTION

Various recording systems are used to form images on recording media. For example, computer-to-plate systems (also known as CTP systems) are used to form images on printing plates using various exposure techniques. A plurality of exposed printing plates is provided to a printing press where images from each printing plate are transferred to paper or other suitable surfaces. It is important that the plurality of images be accurately aligned with respect to one another to ensure an accurate registration among the images. It is important that each image be geometrically correct and free from distortion to achieve desired quality characteristics of the finished printed article. Geometric characteristics of an image can involve, but are not limited to: a desired size or shape of an image portion, or a desired alignment of one image portion with another image portion.

The geometric accuracy of the images formed on a recording media is dependant on numerous factors. For example, images can be formed on recording media by mounting the media on a media support and operating a source to direct imaging beams towards the recording media to form the images thereupon. The images are typically formed by scanning the recording media with the imaging beams during a plurality of scans. The positioning accuracy of the imaging beams with respect to the recording media impacts the geometric correctness of the formed images. Deviations in required positioning of the imaging beams during each scan can lead to errors.

Thermally induced changes have been known to impact the geometric accuracy of the formed images. For example, various precision motion systems are typically employed to provide relative movement between the supported recording media and the source of the imaging beams during the scanning. Carriages adapted to translate the source of the imaging beams relative to the recording media typically employ guide members that are attached to a frame or support member. Various design considerations can require that the guide members be formed from different materials than the support member to which they are attached. For example, guide members are typically made from precision ground steel stock to facilitate the guiding requirements of the motion system whereas the support member is typically made from materials that are subjected different or less stringent requirements. Support members can include lighter weight materials (e.g. various aluminum alloys) to address weight considerations. The use of dissimilar materials having different thermal expansion rates (e.g. steel and aluminum) can cause both of the guide members and the support member to bend in one or more planes when these members experience a temperature rise or fall due to a change in external ambient temperature conditions, or a temperature change arising from the cycling of various internal systems within the apparatus. Thermal bending arising from the use of materials comprising different thermal rates of expansion is typically referred to as the bi-metal effect. Thermal bending effects associated with the guide members and the base member can adversely impact positioning accuracy of the imaging beams with respect to the recording media.

There remains a need for effective and practical methods and systems to correct geometric distortions of images formed on a recording media by a recording system subjected to varying temperatures.

There remains a need for effective and practical methods and systems that can improve the positioning accuracy of imaging beams emitted by an imaging beam source which is positioned along guide members having different thermal expansion rates than those of a support to which the guide members are fixedly attached.

### SUMMARY OF THE INVENTION

Briefly, according to one aspect of the present invention A recording apparatus includes a media support adapted to receive recording media. One or more guide members are attached to the support and extend along a first direction substantially perpendicular to a first neutral axis and a second neutral axis associated with an assemblage comprising at least the support and the guide members. A carriage is adapted to move along the guide members and operable for moving a recording head along a path relative to the media support while forming an image on the recording media. One or more thermal compensation members is fixedly attached to the support to reduce distortions of the assemblage about both the first neutral axis. The second neutral axis, the distortions arise from a difference in thermal expansion between the each of the one or more guide members and the support.

### BRIEF DESCRIPTION OF THE DRAWINGS

Embodiments and applications of the invention are illustrated by the attached non-limiting drawings. The attached drawings are for purposes of illustrating the concepts of the invention and may not be to scale.

FIG. 1 is a partial schematic perspective view of an image forming apparatus that can be employed in an example embodiment of the invention;

FIG. 2 is a schematic plan view of a target image to be formed on recording media;

FIG. 3 is a schematic plan view of a distorted calibration image corresponding to the target image of FIG. 2;

FIG. 4 is a schematic cross-sectional view of an assemblage including guide members affixed to a support;

FIG. 5A is schematic view of the assemblage of FIG. 4 distorted in a Y-Z plane under the influence of a thermal change;

FIG. 5B is schematic view of the assemblage of FIG. 4 distorted in a X-Z plane under the influence of a thermal change;

FIG. 6 is a schematically cross-sectional view of an assemblage made up of a support, guide members and a thermal compensation member as per an example embodiment of the invention;

FIG. 7A is a schematic cross-sectional view of an assemblage made up of a support, guide members and a plurality of thermal compensation members as per an example embodiment of the invention;

FIG. 7B is a schematic cross-sectional view of an assemblage made up of a support, guide members and a plurality of thermal compensation members as per another example embodiment of the invention; and

FIG. 7C is a schematic cross-sectional view of an assemblage made up of a support, guide members and a plurality of thermal compensation members as per yet another example embodiment of the invention.

### DETAILED DESCRIPTION OF THE INVENTION

Throughout the following description specific details are presented to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

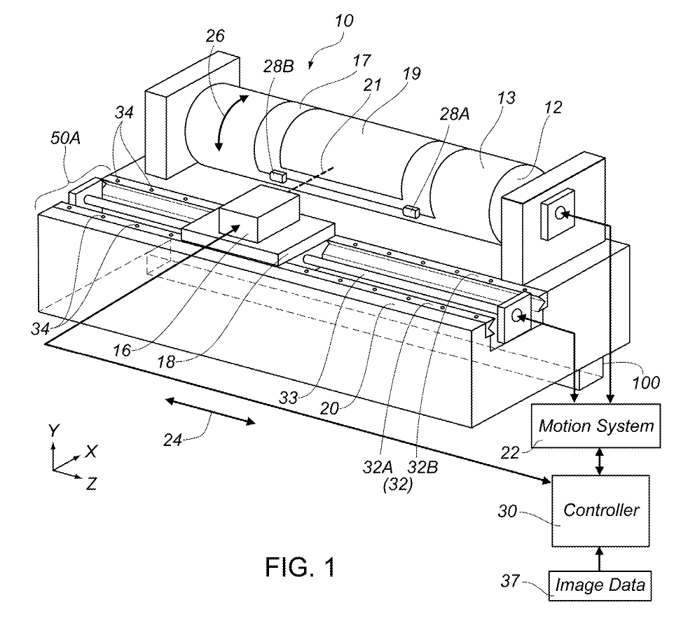

FIG. 1 schematically shows an apparatus 10 that can be employed in an example embodiment of the invention. In this example embodiment, apparatus 10 is employed to form images 19 on a recording media 17. Apparatus 10 includes a media support 12. In this example embodiment, media support 12 includes a cylindrical imaging drum. Other examples embodiments of the invention can include other forms of media supports 12 such as internal drum configurations or flat surface configurations. Recording media 17 is supported on a surface 13 of media support 12. One or more edge portions of recording media 17 are secured to surface 13 by clamps 28A and 28B. Other example embodiments of the invention can secure recording media 17 to media support 12 by other methods. For example, a surface of recording media 17 can be secured to surface 13 by various methods including providing low pressure (e.g. suction) between the surfaces.

Apparatus 10 includes recording head 16 which is movable with respect to media support 17. In this example embodiment of the invention, recording head 16 is mounted on movable carriage 18. Carriage 18 is moved relative to support 20 to move recording head 16 along a path aligned with a rotational axis of media support 12. In this example embodiment of the invention, recording head 16 moves along a path aligned with sub-scan axis 24. In this example embodiment, media support 12 rotationally moves about its rotational axis along a direction of main-scan axis 26. Motion system 22 is used to establish relative movement between recording head 16 and media support 12. Motion system 22 (which can include one or more motion systems) can include any suitable drives and or actuators needed for the required movement. In this example embodiment of the invention, motion system 22 is used to move media support 12 along a path aligned with main-scan axis 26 while moving recording head 16 along a path aligned with sub-scan axis 24. Guide members 32A and 32B (i.e. collectively referred to as guide members 32) are used to guide carriage 18 which is moved under the influence of transmission member 33. In this example embodiment of the invention, transmission member 33 includes a threaded screw. Those skilled in the art will realize that other forms of movement are also possible. For example, recording head 16 can be stationary while media support 12 is moved. In other cases, media support 12 is stationary and recording head 16 is moved. In some example embodiments, one or both of recording head 16 and media support 12 can reciprocate along corresponding paths. Separate motion systems can also be used to operate different systems within apparatus 10.

For descriptive clarity, a coordinate reference frame employing orthogonal X, Y, and Z axes is shown. In this example embodiment, the Z axis is parallel to a direction of sub-scan axis 24. In this example embodiment, guide members 32 each extend along a direction that is substantially parallel to the Z axis.

In this example embodiment, recording head 16 includes a radiation source (not shown), such as a laser. Recording head 16 is controllable to direct one or more imaging beams 21 (i.e. shown in broken lines) capable of forming image 19 on recording media 17. The imaging beams generated by recording head 16 are scanned over recording media 17 while being image-wise modulated according to image data specifying the image to be written. One or more imaging channels are driven appropriately to produce imaging beams with active intensity levels wherever it is desired to expose recording media 17 to form an image portion. Imaging channels not corresponding to the image portions are driven so as not to image corresponding areas. Image 19 can be formed on recording media 17 by different methods. For example, recording media 17 can include an image modifiable surface, wherein a property or characteristic of the modifiable surface is changed when exposed by imaging beam 21 to form an image. Imaging beam 21 can be used to ablate a surface of recording media 17 to form an image. Imaging beam 21 can be used to facilitate a transfer of an image forming material to a surface of recording media 17 to form an image (e.g. a thermal transfer process). Recording head 16 can include a plurality of channels that can be arranged in an array. An array of imaging channels can include a one-dimensional or two-dimensional array of imaging channels. Imaging beam 21 can undergo a direct path from a radiation source to recording media 17 or can be deflected by one or more optical elements towards recording media 17.

Groups of imaging channels can form an image swath having a width related to the distance between a first pixel imaged and a last pixel imaged during a given scan. Recording media 17 is typically too large to be imaged within a single imaged swath. Multiple imaged swaths are typically formed to complete an image on recording media 17.

Controller 30, which can include one or more controllers is used to control one or more systems of apparatus 10 including, but not limited to, various motion systems 22 used by media support 12 and carriage 18. Controller 30 can also control media handling mechanisms that can initiate the loading and/or unloading of recording media 17 to and/or from media support 12. Controller 30 can also provide image data 37 to recording head 16 and control recording head 16 to emit imaging beams 21 in accordance with this data. Various systems can be controlled using various control signals and/or implementing various methods. Controller 30 can be configured to execute suitable software and can include one or more data processors, together with suitable hardware, including by way of non-limiting example: accessible memory, logic circuitry, drivers, amplifiers, A/D and D/A converters, input/output ports and the like. Controller 30 can comprise, without limitation, a microprocessor, a computer-on-a-chip, the CPU of a computer or any other suitable microcontroller.

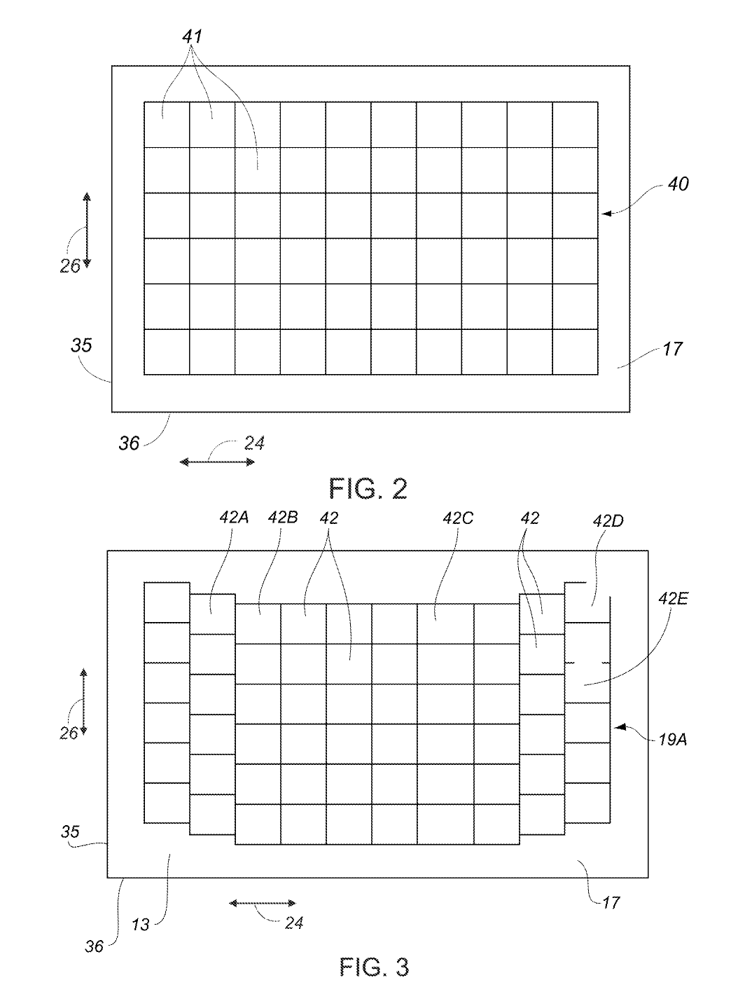

Apparatus 10 can used to form various desired images on recording media 17. One such image is target image 40 as shown in FIG. 2. In this example, target image 40 comprises a precise grid pattern made up of target cells 41 which are defined by image boundaries of a desired size. In this example embodiment, target cells 41 are square shaped. Target image 40 is represented in a desired alignment with various edges of recording media 17 which is shown in an unwrapped or “flat” orientation for clarity. Specifically, it is desired to form target image 40 referenced with respect to edge 35 and edge 36 of recording media 17. In this example embodiment, edge 35 is to be aligned with main-scan axis 26 and edge 36 aligned with sub-scan axis 24. In this example embodiment, geometric characteristics of target image 40 are described in relationship with main-scan axis 26 and sub-scan axis 24.

Target image 40 is represented by image data 37 and is provided to controller 30 to form an image 19 on recording media 17. In this example embodiment of the invention, controller 30 controls motion system 22 to cause create relative movement between recording head 16 and recording media 17 during the imaging. In this example embodiment of the invention, recording head 16 is translated in a coordinated manner with the rotation of media support 12 to form helically oriented image swaths.

FIG. 3 schematically shows an example calibration image 19A formed on recording media 17 in response to the desired imaging of target image 40 by recording head 16. For clarity, recording media 17 is depicted in a “flat” orientation. Calibration image 19A includes a plurality of imaged cells 42 corresponding to target cells 41. As shown in FIG. 3, calibration image 19A is distorted and does not correspond exactly to target image 40. Various imaging distortions appear in different areas of calibration image 19A. Various imaged cells 42 such as imaged cells 42A, 42C, 42D, and 42E do not correspond exactly to the pattern of target cells 41. For example, a column of imaged cells 42 including imaged cell 42A is shifted along a direction of main-scan axis 26 with respect to a column of imaged cells 42 that include imaged cell 42B. FIG. 3 also shows that various imaged cells including imaged cell 42C are elongated in size along a direction of sub-scan axis 24 as compared to corresponding target cells 41. Further, imaged cells 42D and 42E are not fully formed. It is understood that the distorted image cells 42A, 42C, 42D, and 42E are described by way of example, and other imaged cells 42 in calibration image 19A can be also distorted in similar or different manners.

Image distortions can occur for several reasons. In this case, the illustrated distortions arise from temperature variances which cause distortion in an assemblage 50A made up of guide members 32 and support 20. In this case, guide members 32A and 32B are made from materials that have different coefficients of thermal expansion than support 20 to which they are affixed. In the example embodiment of the invention shown in FIG. 1, guide members 32A and 32B are made from precision ground steel stock of sufficient hardness to endure contact stresses imposed by carriage 18 positioned thereupon and to provide the positional accuracy required during the movement of carriage 18. Support 20 on the other hand is much large in size than guide members 32A and 32B and is made from a lighter weight material, which in this illustrated embodiment includes an aluminum alloy. Various steel alloys typically have an average coefficient of thermal expansion of approximately 1.2×10⁻⁵ per ° C. while various aluminum alloys have a higher average coefficient of thermal expansion of approximately 2.3×10⁻⁵ per ° C.

In this example embodiment, each of the guide members 32A and 32B extends along a first direction that is parallel to a direction of sub-scan axis 24. Each of guide members 32A and 32B is fixedly attached to support 20 at plurality of attachment points along the first direction. In some example embodiments, each of guide members 32A and 32B is fastened to support 20 at attachment points proximate to the ends of guide members 32A and 32B. In some example embodiments, various portions of guide members 32A and 32B inboard of their fixedly attached ends are not supported by support 20. In other example embodiments, various portions of guide members 32A and 32B inboard of their fixedly attached ends are contiguously attached to support 20. In this example embodiment of the invention, each of guide members 32A and 32B are fixedly attached to a support 20 at series of attachment points located along the lengths of the guide members 32. In this example embodiment, each of guide members 32A and 32B are fixedly attached to support 20 by a series of fasteners 34. It is understood that other example embodiments of the invention need not be limited to two guide members 32 and may employ other suitable numbers of guide members 32, and each of the guide members 32 can be affixed to support 20 by other suitable methods known in the art. In some example embodiments, a single guide member 32 is fixedly attached to support 20 in a manner similar to those previously described.

Guide members 32 are typically fixedly attached to support 20 in manner which can constrain an elongation or contraction of a portion of support 20 that may arise as a consequence of a change in thermal conditions. Different expansion rates associated with the dissimilar materials used in the assemblage 50A cause assemblage 50A to distort under the influence of temperature changes and the constraints imposed by the attachment guide members 32 to support 20. Temperature changes can take the form of ambient external environmental temperature changes and/or internal temperature changes caused by the operation of various systems within apparatus 10.

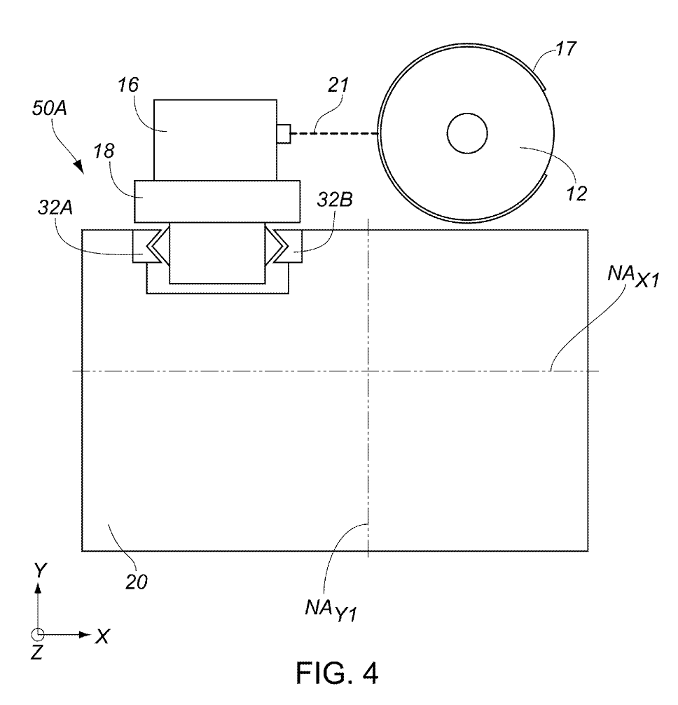

Thermal changes can cause assemblage 50A to distort differently along different directions. For example, FIG. 4 shows a schematic cross-sectional view of assemblage 50A. For clarity, some elements of apparatus 10 that are present in FIG. 1 are not shown in FIG. 4. As shown in FIG. 4, guide members 32A and 32B are not symmetrically affixed to support 20. In particular guide members 32A and 32B are positioned on a surface of support 20 to position recording head 16 along the Y axis to appropriately direct imaging beams 21 towards a desired region on media support 12. Guide members 32A and 32B are also affixed along the X axis to one side of support 20 to accommodate the space required by media support 20.

The asymmetrical mounting of guide members 32A and 32B can cause assemblage 50A to bend in various directions under the influence of thermal changes. Specifically, temperature increases or decreases will cause the assemblage 50A to bend about each of neutral axis NA_{X1} and neutral axis NA_{Y1}. As assemblage 50A bends under the influence of thermal changes, various portions of assemblage 50A will be in tension while other positions will be in compression. The tensioned portions are separated from the compressed portions by a plane that is free of stress and strain resulting from the thermally induced bending. In this example embodiment, this plane extends along the length of assemblage 50A (i.e. along the Z axis) and is referred to as to as the neutral surface. Each of neutral axis NA_{X1} and neutral axis NA_{Y1} correspond to a right section through a corresponding neutral surface. The position of each of neutral axis NA_{X1} and neutral axis NA_{Y1} can be estimated by the summation of second moments of inertia as referenced with the corresponding X and Y axes. In many cases, the moment of inertia of the support 20 will be much greater than the moment of inertias of guide members 32A and 32B and the positions of neutral axis NA_{X1} and neutral axis NA_{Y1} will not significantly vary from the positions of corresponding neutral axes of support 20 if considered alone. In this example embodiment, each of neutral axis NA_{X1} and neutral axis NA_{Y1} extend along respective directions that intersect a direction of the Z axis. In this example embodiment, each of neutral axis NA_{X1} and neutral axis NA_{Y1} extend along respective directions that intersect a direction along which guide members 32A and 32B extend. In this example embodiment, each of neutral axis NA_{X1} and neutral axis NA_{Y1} extend along respective directions that are substantially perpendicular to a rotational axis of media support 12. In this example embodiment, neutral axis NA_{X1} extends along a direction that is substantially perpendicular to a direction of main-scan axis 26 and to a direction of sub-scan axis 24. In this example embodiment, neutral axis NA_{Y1} extends along a direction that is substantially perpendicular to a direction of sub-scan axis 24. In this example embodiment, neutral axis NA_{Y1} extends along a direction that is substantially parallel to a direction of main-scan axis 26.

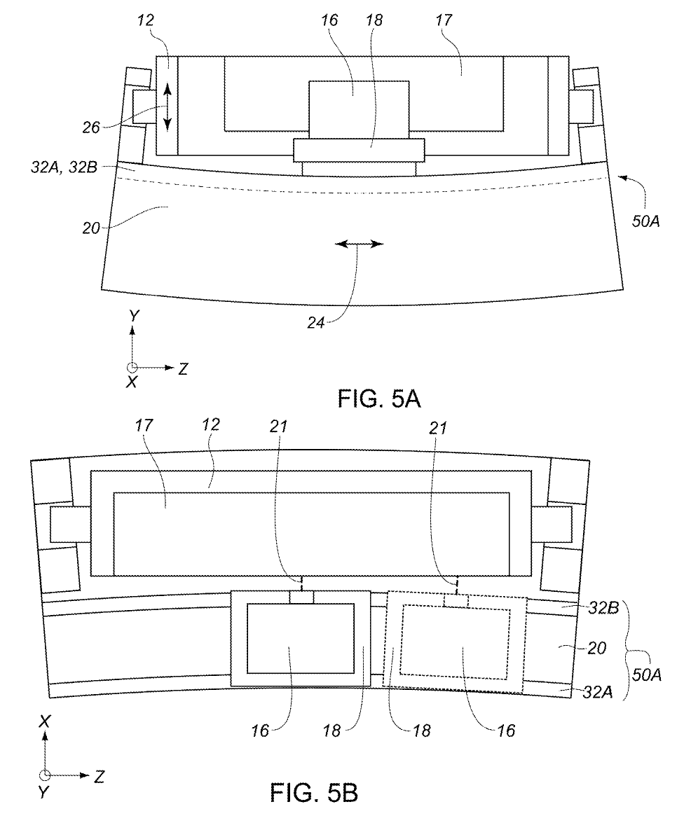

Bending about each of neutral axis NA_{X1} and neutral axis NA_{Y1} can adversely affect a desired positioning of imaging beams 21. For example, thermal changes can cause assemblage 50A to bend about neutral axis NA_{X1} such that assemblage 50A bends in a concave or convex manner in a plane defined by the Y and Z axes as schematically shown in FIG. 5A. It is to be noted that that amount of bending of assemblage 50A shown in FIG. 5A has been exaggerated for clarity. The shape of the bent form will depend on the particular coefficients of thermal expansion of each of the guide members 32A and 32B and support 20. The shape of the bent form will depend on whether a temperature increase or a temperature decrease occurs. Typically, a temperature increase will cause assemblage 50A to bend away from the component having the largest coefficient thermal expansion (i.e. support 20 in this case). This occurs because the component having the lower coefficient of thermal expansion will constrain the component having the larger coefficient of thermal expansion from fully expanding under the increased temperature. As schematically shown in FIG. 5A, a temperature changed has caused assemblage 50A to bend upwards in the Y-Z plane.

Thermal changes which cause assemblage 50A to bend about neutral axis NA_{X1} can lead main-scan deviations in a desired projection of imaging beams 21 onto recording media 17 as recording head 16 is positioned at various locations along guide members 32A and 32B. In this case, distorted guide members 32A and 32B cause varying displacements of recording head 16 with respect to media support 12 along the Y axis to cause main-scan deviations. Main-scan deviations can lead to various image distortions such as the shifted imaged cell 42A shown in FIG. 3.

Thermal changes can cause assemblage 50A to bend about neutral axis NA_{Y1} such that assemblage 50A bends in a concave or convex manner in a plane defined by the X and Z axes as schematically shown in FIG. 5B. Again, the amount of bending of assemblage 50A shown in FIG. 5B has been exaggerated for clarity. The shape of the bent form will again depend on the particular coefficients of thermal expansion of each of the guide members 32A and 32B and support 20 and on whether a temperature increase or decrease is encountered. As shown in FIG. 5B, a temperature change has caused assemblage 50A to bend away from media support 12 in the X-Z plane.

Thermal changes which cause assemblage 50A to bend about neutral axis NA_{Y1} can lead to sub-scan deviations in a desired projection of imaging beams 21 onto recording media 17 as recording head 16 is positioned at various locations along guide members 32A and 32B. As shown in FIG. 5B, distortions in guide members 32A and 32B can cause recording head 16 to yaw by various amounts as it positioned at different locations along guide members 32A and 32B. As recording head 16 undergoes yawing movements, corresponding sub-scan displacements of imaging beams 21 from their intended targets on recording media will arise. This in turn can lead to various image distortions such as elongated cells 42D in FIG. 3. For clarity, recording head 16 is shown in broken lines at a second location in FIG. 5B to illustrate the yawed positioning.

As also shown in FIG. 5B, distortions in guide members 32A and 32B can cause recording head 16 to be displaced by varying amounts along the X axis as recording head 16 is positioned at different locations along guide members 32A and 32B. During exposure, each of imaging beams is focused at a specific point in relation to recording media 17. Since a relatively small depth of focus can be associated with imaging beams 21, various deviations from their desired focal points can lead to imaged pixel size variations and/or exposure variations which can degrade the desired image. Autofocus systems are typically employed to compensate for depth-of-focus issues. However, typical autofocus systems have limited operating detection ranges that are often insufficient to correct for some focus problems created by displacements arising from the bending of assemblage 50A about neutral axis NA_{Y1}. Imaged cell 42E in FIG. 3 is an example of an image portion that has not been properly formed due to thermal displacements in the X-Z plane.

The thermally induced bending displacements are typically proportional to the square of the length of assemblage 50A (i.e. along the Z axis in this case). Recent trends require that computer-to-plate systems expose printing plates of ever increasing size with some printing plates having sizes on the order of three meters or more. These significantly larger printing plates in turn require larger exposure apparatus which are more consequently more susceptible to thermal distortions than conventional systems employed to expose smaller printing plates.

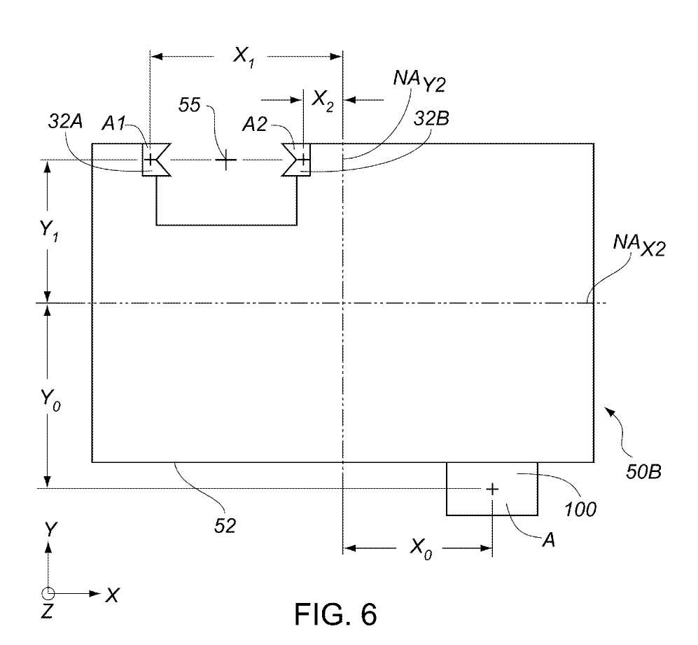

FIG. 6 schematically shows a cross-sectional view of an assemblage 50B made up of support 20 and guide members 32A and 32B and a thermal compensation member 100 as per an example embodiment of the invention. In this example embodiment, thermal compensation member 100 is affixed to assemblage 50A to compensate for, or to reduce to acceptable levels thermally induced distortions. In this example embodiment, the positions of guide members 32 and thermal compensation member 100 are referenced with respect to neutral axis NA_{X2} and neutral axis NA_{Y2}. In this example embodiment, the positions of each of neutral axis NA_{X2} and neutral axis NA_{Y2} can vary from the positions of the previously described neutral axis NA_{X1} and neutral axis NA_{Y1} since they are also take into consideration the presence of thermal compensation member 100. In many cases the moment of inertias of guide members 32A and 32B and thermal compensation member 100 are substantially smaller than the moment of inertia of support 20. In these cases, the positions of neutral axis NA_{X2} and neutral axis NA_{Y2} may not significantly vary from the positions of the corresponding neutral axes of support 20 when considered alone.

In this example embodiment, thermal compensation member 100 is an elongate member. In this example embodiment, thermal compensation member 100 extends in direction generally parallel to a direction that guide members 32A and 32B extend along. In this example embodiment, thermal compensation member 100 comprises an extended length that is generally equal to the extended length of each of guide members 32A and 32B. Thermal compensation member 100 is fixedly attached at a plurality of locations on a surface of support 20. In some example embodiments, thermal compensation member 100 is fastened to support 20 at locations proximate to the extended ends of thermal compensation member 100. In some example embodiments, thermal compensation member 100 is fixedly attached to support 20 at series of points located along the extended length of thermal compensation member 100. In other example embodiments, thermal compensation member 100 and each of guide members 32A and 32B are fixedly attached to support 20 such that a first attachment point and a last attachment point between thermal compensation member 100 and support 20 coincide respectively with a first attachment point and a last attachment point between each of guide members 32A and 32B and support 20. In this example embodiment, thermal compensation member 100 is affixed to support 20 in a manner suitable to resist thermally induced bending effects associated with the attachment of guide members 32 to support 20. In this example embodiment, thermal compensation member 100 is sized and affixed to support 20 in a manner to reduce at least one of a main-scan image distortion and a sub-scan image distortion that can arise as a consequence of changes in thermal conditions.

As shown in FIG. 6, guide member 32A has a cross-sectional area A₁ in a plane defined by neutral axes NA_{X2} and NA_{Y2} (i.e. the neutral axis plane) while guide member 32B has a cross-sectional area A₂ in the neutral axis plane. Thermal compensation member 100 is shown with a cross-sectional area A in the neutral axis plane. As previously described, an asymmetrical attachment of guide members 32 to support 20 can cause thermally induced bending effects to occur about each of the plurality of neutral axes associated with the assemblage. In this example embodiment, one of the plurality of neutral axes NA_{X2} and NA_{Y2} is selected, and a size of the cross-sectional area A is determined to reduce or effectively compensate for thermally induced bending effects about the selected one of the neutral axes NA_{X2} and NA_{Y2}. In this example embodiment, a location on a surface of support 20 to which thermal compensation member 100 is affixed is additionally determined to reduce or effectively compensate for thermally induced bending effects about the other of neutral axes NA_{X2} and NA_{Y2}.

The required size of cross-sectional area A and the required positioning of thermal compensation member 100 can be determined in various ways, including by direct experimentation. The following relationships refer to FIG. 6 and can be used to estimate a cross-sectional area A and a positioning of thermal compensation member 100 which are required to compensate for thermally induced bending effects about each of neutral axes NA_{X2} and NA_{Y2}:

((A₁*X₁)+(A₂*X₂))*Δα_{GM}*E_{GM}≃A* X₀*Δα_{TM}*E_{TM}; and 1)

(A₁+A₂)*Y₁*Δα_{GM}*E_{GM}≃A*Y₀*Δα_{TM}*E_{TM}; 2)
where:

A₁ is a cross-sectional area of guide member 32A;

A₂ is a cross-sectional area of guide member 32B;

X₁ is a distance between guide member 32A and neutral axis NA_{Y2};

X₂ is a distance between guide member 32B and neutral axis NA_{Y2};

Y₁ is a distance between guide members 32A and 32B and neutral axis NA_{X2};

Δα_{GM} is a difference amount between the coefficient of thermal expansion of guide members 32 and the coefficient of thermal expansion of support 20;

E_{GM} is the modulus of elasticity of guide members 32;

A is a cross-sectional area of thermal compensation member 100;

X₀ is a distance between thermal compensation member 100 and neutral axis NA_{Y2};

Y₀ is a distance between thermal compensation member 100 and neutral axis NA_{X2};

Δα_{TM} is a difference amount between the coefficient of thermal expansion of thermal compensation member 100 and the coefficient of thermal expansion of support 20; and

E_{TM} is the modulus of elasticity of thermal compensation member 100.

Relationships 1) and 2) where derived by equating relationships that described maximum bending deflections associated with each of guide members 32 and thermal compensation member 100. In some example embodiments, thermal compensation member 100 is made from a material composition having similar material properties to those of guide members 32. In some example embodiments, thermal compensation member 100 comprises a material composition whose coefficient of thermal expansion is substantially similar to that of guide members 32. In yet other example embodiments, thermal compensation member 100 comprises a material whose modulus of elasticity is substantially similar to the modulus of elasticity of guide members 32. Thermal compensation member 100 can include a material composition that is the same or different than a material composition of guide members 32. When thermal compensation member 100 comprises material properties such that (Δα_{TM}*E_{TM})≃(Δα_{GM}*E_{GM}), then relationships 1) and 2) above can be simplified as follows:

(A₁*X₁)+(A₂*X₂)≃A*X₀; and 3)

(A₁+A₂)*Y₁≃A*Y₀. 4)

Relationships 3) and 4) indicate that the selection of a particular one of the three variables A, X₀, and Y₀ in accordance with a desire to reduce thermally induced bending effects about one of neutral axes NA_{X2} and NA_{Y2} affects the possible choices for the selection of another of the three variables required to reduce thermally induced bending effects about the other one of neutral axes NA_{X2} and NA_{Y2}. Manufacturing complexities can typically be reduced by affixing thermal compensation member 100 to a surface of support 20 rather than integrally incorporating the member with support 20 (i.e. by a casting process, for example). In this example embodiment of the invention, surface 52 of support 20 is selected to affix thermal compensation member 100 to. In this example embodiment, surface 52 corresponds to a portion of support 20 that is spaced furthest away from neutral axis NA_{X2}. The material requirements of thermal compensation member 100 can be reduced since a smaller cross-sectional section A is required to compensate for the thermally induced bending about neutral axis NA_{X2} at this location. In this example embodiment, cross-sectional area A is sized based on distance Y₀ in accordance with relationship 4).

In this example embodiment, surface 52 was further selected since it extended sufficiently to a region in which thermal compensation member 100 could be appropriately attached at required distance X₀ to compensate for thermally induced bending effects about neutral axis NA_{Y2}. In various embodiments of the invention, the selection of one or more of variables A, X₀, and Y₀ can be motivated by various factors including, but not limited to, the availability of suitable mounting surfaces on support 20 and various space constraints associated with apparatus 10.

As shown in FIG. 6, a single thermal compensation member 100 is affixed to a location on support 20 that is different from an attachment location of each of guide members 32A and 32B. In this example embodiment, the attachment location of thermal compensation member 100 is separated by both of neutral axes NA_{X2} and NA_{Y2} from an attachment location of each of guide members 32A and 32B. In some example embodiments of the invention, thermal compensation member 100 is separated from at least one of guide members 32 by each of neutral axes NA_{X2} and NA_{Y2}. In this example embodiment, a centroid 55 corresponding to a center of the cross-sectional areas of guide members 32A and 32B is shown separated from an attachment location of thermal compensation member 100 by each of neutral axes NA_{X2} and NA_{Y2}.

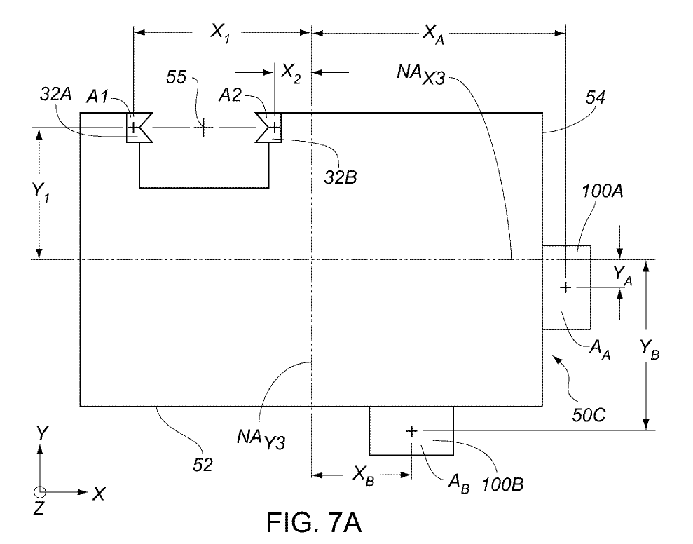

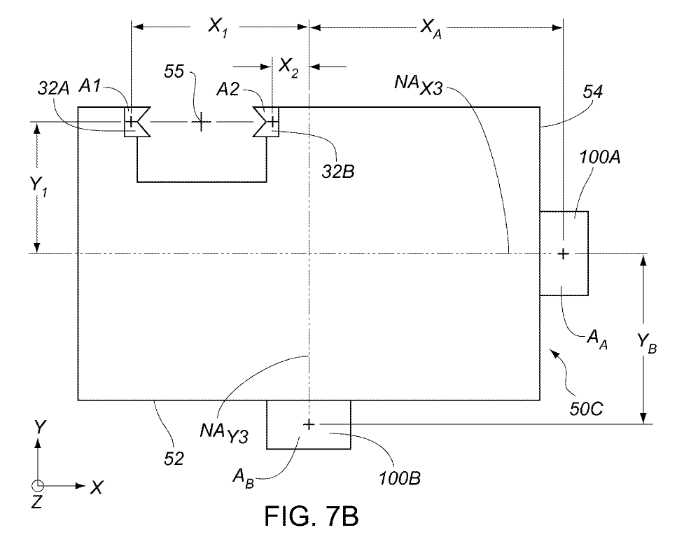

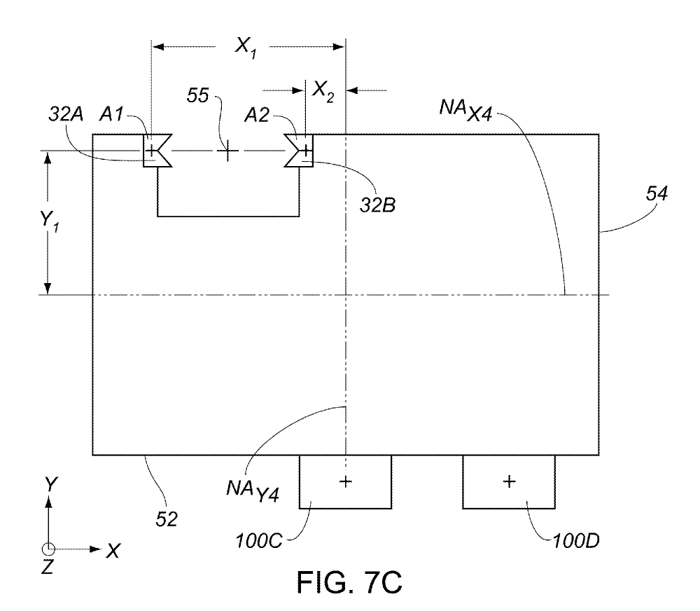

In some example embodiments of the invention, a plurality of thermal compensation members is employed. For example, FIG. 7A shows a cross-sectional view of an assemblage 50C made up of support 20, guide members 32A and 32B, and a plurality of thermal compensation members as per an example embodiment of the invention. In this example embodiment, the plurality of thermal compensation members includes comprising thermal compensation member 100A and thermal compensation member 100B. In this example embodiment, each of thermal compensation members 100A and 100B comprises an extended length that is generally equal to the extended length of each of guide members 32A and 32B. In this example embodiment, each of thermal compensation members 100A and 100B are affixed to support 20 in a manner similar to those previously described. In this example embodiment, each of thermal compensation members 100A and 100B are affixed to support 20 to compensate for, or to reduce to acceptable levels, distortions created by thermally induced bending effects about each of neutral axis NA_{X3} and neutral axis NA_{Y3}. The positions of each of neutral axis NA_{X3} and neutral axis NA_{Y3} can vary from the positions of the previously described neutral axes NA_{X1} and NA_{Y1} since their positions are defined in accordance with the presence of thermal compensation members 100A and 100B.

Variants of relationships 1) and 2) which can be used to estimate required cross-sectional areas and locations of each of the thermal compensation members 100A and 100B that are required to compensate for thermally induced bending effects about each of neutral axes NA_{X3} and NA_{Y3} are presented as follows:

((A₁*X₁)+(A₂*X₂))*Δα_{GM}*E_{GM}≃(A_{A}*X_{A})*Δα_{TMA}*E_{TMA}+(A_{B}*X_{B})*Δα_{TMB}*E_{TMB} and 5)

(A₁+A₂)*Y₁*Δα_{GM}*E_{GM}≃(A_{A}*Y_{A})*Δα_{TMA}*E_{TMA}+(A_{B}*Y_{B})*Δα_{TMB}*E_{TMB}; where: 6)

A_{A} is a cross-sectional area of thermal compensation member 100A in the neutral plane;

A_{B} is a cross-sectional area of thermal compensation member 100B in the neutral plane;

X_{A} is a distance between thermal compensation member 100A and neutral axis NA_{Y3};

X_{B} is a distance between thermal compensation member 100B and neutral axis NA_{Y3};

Y_{A} is a distance between thermal compensation member 100A and neutral axis NA_{X3};

Y_{B} is a distance between thermal compensation member 100B and neutral axis NA_{X3};

Δα_{TMA} is a difference amount between the coefficient of thermal expansion of thermal compensation member 100A and the coefficient of thermal expansion of support 20;

Δα_{TMB} is a difference amount between the coefficient of thermal expansion of thermal compensation member 100B and the coefficient of thermal expansion of support 20;

E_{TMA} is the modulus of elasticity of thermal compensation member 100A;

E_{TMB} is the modulus of elasticity of thermal compensation member 100B; and

Variables A₁, A2, Δα_{GM}, and E_{GM} are as previously defined. Variables X₁, X₂, and Y₁ are as previously defined but are referenced with respect to neutral axes NA_{X3} and NA_{Y3} in this example embodiment.

In example embodiments of the invention in which thermal compensation members 100A and 100B each comprise material properties such that (Δα_{TMA}*E_{TMA})≃(Δα_{TMB}*E_{TMB})≃(Δα_{GM}*E_{GM}), relationships 5) and 6) can be simplified as follows:

(A₁*X₁)+(A₂*X₂)≃(A_{A}*X_{A})+(A_{B}*X_{B}); and 7)

(A₁+A₂)*Y₁≃(A_{A}*Y_{A})+(A_{B}*Y_{B}). 8)

Those skilled in the art will realize that further relationships similar to relationships 5), 6), 7) and 8) can be established for other embodiments of the invention that employ different numbers of thermal compensation members. Simplified relationships 7) and 8) again highlight various interdependencies between the variables A_{A}, A_{B}, X_{A}, X_{B}, Y_{A}, and Y_{B} that require consideration to reduce thermally induced bending effects about each of the neutral axes NA_{X3} and NA_{Y3}. In this example embodiment, some of the variables are selected in accordance with a desire to affix each of thermal compensation members 100A and 100B to particular surfaces of support 20. As shown in FIG. 7A, thermal compensation member 100B is affixed to surface 52 while thermal compensation member 100A is affixed to surface 54. In this example embodiment each of the affixed surfaces of support 20 is intersected by one of the neutral axes NA_{X3} and NA_{Y3}. In this example embodiment, distances X_{A} and Y_{B} are accordingly related at least in part by the location of surfaces 52 and 54. Values for the remaining variables of A_{A}, A_{B}, X_{B}, and Y_{A} can then be determined in accordance with the requirements of the previously stated relationships.

In one particular embodiment of the invention shown in FIG. 7B, each of the thermal compensation members 100A and 100B are located on their corresponding surfaces 52 and 54 at locations proximate to a point of intersection by one of neutral axes NA_{X3} and NA_{Y3}. In this illustrated embodiment, each one of the thermal compensation members 100A and 100B can be sized to compensate for thermally induced bending effects about a corresponding one of neutral axes NA_{X3} and NA_{Y3} more or less independently of one another since distances X_{B} and Y_{A} are sufficiently small enough to be considered inconsequential. In other example embodiments, a plurality of thermal compensation members need not be distributed on different surfaces support 20, but rather can be affixed to a common surface of support 20. For example, FIG. 7C shows an example embodiment, in which a plurality of thermal compensation members 100C and 100D are affixed to surface 52 to compensate for thermally induced bending effects about each of neutral axes NA_{X4} and NA_{Y4}. Each of thermal compensation members 100C and 100D are sized and positioned on surface 52 by techniques similar to those employed in other described embodiments of the invention. For example, relationships 7) and 8) can be used to estimate desired sizing and positioning parameters for each of thermal compensation members 100C and 100D.

Those skilled in the art will realize that various other configurations of one or more thermal compensation members can be employed to counter both main-scan and sub-scan image distortions that can arise from thermal changes. Advantageously, main-scan and sub-scan image distortions can be reduced to acceptable levels by employing various embodiments of the present invention especially when uncommonly large exposure systems are employed.

In some example embodiments of the invention the cross-sectional areas of one or more of the guide members 32, the support 20 and at least one thermal compensation member 100 can be constant along their extended length. In other example embodiments, the cross-sectional areas of one or more of the guide members 32, the support 20 and at least one thermal compensation member 100 can vary along their extended length. In some particular example embodiments, one or both of a positional attribute and a size attribute associated with a particular thermal compensation member 100 can be made to vary along its extended length. By way of non-limiting example, variances in one or both of these attributes can be made based on variances in a cross-sectional area of support 20 along its extended length. Variances in the cross-sectional area of support 20 can occur when support 20 is formed in a casting process for example.

In some example embodiments, images are formed on recording media 17 by non-exposure techniques. For example, in some embodiments recording head 16 is adapted to transfer image forming material onto recording media 17. By way of non-limiting example, recording head 16 can include an inkjet recording head.

The invention has been described in detail with particular reference to certain preferred embodiments thereof, but it will be understood that variations and modifications can be effected within the scope of the invention.

### PARTS LIST

10 apparatus
12 media support
13 surface
16 recording head
17 recording media
18 carriage
19 image
19A calibration image
20 support
21 imaging beam
22 motion system
24 sub-scan axis
26 main-scan axis
28A clamp
28B clamp
30 controller
32 guide members
32A guide member
32B guide member
33 transmission member
34 fasteners
35 edge
36 edge
37 image data
40 target image
41 target cells
42 imaged cells
42A imaged cell
42B imaged cell
42C imaged cell
42D imaged cell
42E imaged cell
50A assemblage
50B assemblage
50C assemblage
52 surface
54 surface
55 centroid
100 thermal compensation member
100A thermal compensation member
100B thermal compensation member
100C thermal compensation member
100D thermal compensation member
A cross-sectional area of a thermal compensation member
A_{A} cross-sectional area of a thermal compensation member
A_{B} cross-sectional area of a thermal compensation member
A₁ cross-sectional area of guide member
A₂ cross-sectional area of guide member
NA_{X1} neutral axis
NA_{X2} neutral axis
NA_{X3} neutral axis
NA_{X4} neutral axis
NA_{Y1} neutral axis
NA_{Y2} neutral axis
NA_{Y3} neutral axis
NA_{Y4} neutral axis
X axis
X_{A} distance between a thermal compensation member and a neutral axis
X_{B} distance between a thermal compensation member and a neutral axis
X₀ distance between a thermal compensation member and a neutral axis
X₁ distance between a guide member and a neutral axis
X₂ distance between a guide member and a neutral axis
Y axis
Y_{A} distance between a thermal compensation member and a neutral axis
Y_{B} distance between a thermal compensation member and a neutral axis
Y₀ distance between a thermal compensation member and a neutral axis
Y₁ distance between guide members and a neutral axis
Z axis

1. A recording apparatus, comprising:
a support;
a media support adapted to receive recording media;
one or more guide members, each of the one or more guide members fixedly attached to the support and extending along a first direction substantially perpendicular to each of a first neutral axis and a second neutral axis associated with an assemblage comprising at least the support and the one or more guide members;
a carriage adapted to move along the one or more guide members and operable for moving a recording head along a path relative to the media support while forming an image on the recording media; and
one or more thermal compensation members, each of the one or more thermal compensation members being fixedly attached to the support to reduce distortions of the assemblage about both the first neutral axis and the second neutral axis, the distortions arising from a difference in thermal expansion between the each of the one or more guide members and the support.

2. The apparatus according to claim 1 wherein each of the one or more thermal compensation members extends along a direction that intersects a plane defined by the first neutral axis and the second neutral axis.

3. The apparatus according to claim 1 wherein each of the one or more thermal compensation members extends substantially along the first direction.

4. The apparatus according to claim 3 wherein each of the one or more thermal compensation members and each of the one or more guide members are substantially equal in size along the first direction.

5. The apparatus according to claim 3 wherein a fixedly attached portion of at least one of the one or more thermal compensation members comprises substantially the same size along the first direction as a fixedly attached portion of at least one of the one or more guide members.

6. The apparatus according to claim 3 wherein at least one of the one or more thermal compensation members and at least one of the one or more guide members are each fixedly attached to the support along the first direction, and a first attachment point and a last attachment point along the first direction of the at least one of the one or more thermal compensation members substantially coincide with a first attachment point and a last attachment point along the first direction of the at least one of the one or more guide members.

7. The apparatus according to claim 2 wherein at least one of the one or more thermal compensation members comprises a cross-sectional area in the plane that is different in size than a cross-sectional area of at least one of the one or more guide members in the plane.

8. The apparatus according to claim 1 wherein each of the one or more thermal compensation members is fixedly attached to a location on the support that is separated by at least one of the first neutral axis and the second neutral axis from a location on the support to which at least one of the one or more guide members is fixedly attached to.

9. The apparatus according to claim 1 wherein at least one of the one or more thermal compensation members is fixedly attached to a location on the support that is separated by both of the first neutral axis and the second neutral axis from a location on the support to which at least one of the one or more guide members is fixedly attached to.

10. The apparatus according to claim 1 wherein the one or more thermal compensation members comprise a plurality of thermal compensation members, and each thermal compensation member of the plurality of thermal compensation members is fixedly attached to a different surface of the support.

11. The apparatus according to claim 1 wherein the one or more thermal compensation members comprise a plurality of thermal compensation members, and each thermal compensation member of the plurality of thermal compensation members is attached to a same surface of the support.

12. The apparatus according to claim 1 wherein at least one of the one or more thermal compensation members is attached to the support at a location in which the at least one of the one or more thermal compensation members is intersected by one of the first neutral axis and the second neutral axis.

13. The apparatus according to claim 1 wherein at least one of the one or more thermal compensation members includes a material having a coefficient of thermal expansion that is substantially the same as a coefficient of thermal expansion of a material comprised by at least one of the one or more guide members.

14. The apparatus according to claim 1 wherein at least one of the one or more thermal compensation members comprises a material having a coefficient of thermal expansion that that varies from a coefficient of thermal expansion of the support by substantially the same amount that a coefficient of thermal expansion of a material comprised by at least one of the one or more guide members varies from the coefficient of thermal expansion of the support.

15. The apparatus according to claim 1 wherein at least one of the one or more thermal compensation members comprises a material having a modulus of elasticity that is substantially the same as a modulus of elasticity of a material comprised by at least one of the one or more guide members.

16. The apparatus according to claim 1 wherein at least one of the one or more thermal compensation members and at least one of the one or more guide members comprise the same material.

17. The apparatus according to claim 1 wherein at least one of the one or more thermal compensation members and at least one of the one or more guide members each comprises material properties such that a product E*Δα is substantially the same for each of the least one of the one or more thermal compensation members and each of the at least one of the one or more guide members, wherein:
E is a modulus of elasticity associated with each of the least one of the one or more thermal compensation members and the at least one of the one or more guide members; and
Δα is a difference between a coefficient of thermal expansion of the support and a coefficient of thermal expansion associated with each of the least one of the one or more thermal compensation members and the at least one of the one or more guide members.

18. The apparatus according to claim 1 wherein the one or more guide members are asymmetrically positioned relative to each of the first neutral axis and the second neutral axis.

19. The apparatus according to claim 2 wherein each of the one or more guide members comprises a cross-sectional area in the plane, and a centroid of the cross-sectional areas is offset from each of the first neutral axis and the second neutral axis.

20. The apparatus according to claim 1 wherein each of the one or more thermal compensation members extends along a direction that is substantially perpendicular to a plane defined by the first neutral axis and the second neutral axis.

21. A method for reducing imaging beam positional errors, comprising:
providing a support;
providing an imaging drum adapted to receive recording media;
providing one or more guide members fixedly attached to the support, wherein each of the one or more guide members extends along a first direction that is substantially perpendicular to each of a first neutral axis and a second neutral axis associated with an assemblage comprising at least the support and the one or more guide members;
providing a carriage adapted for moving along the one or more guide members to move a recording head relative to the imaging drum;
operating the imaging head to directing imaging beams towards the recording media to form an image thereon; and
providing one or more thermal compensation members, wherein each of the one or more thermal compensation members is fixedly attached to the support to reduce at least one of a main-scan positional error and a sub-scan positional error associated with the imaging beams directed towards the imaging drum, and each of the one or more thermal compensation members is separated from at least one of the one of more guide members by at least one of the first neutral axis and the second neutral axis.

22. A method according to claim 21 wherein each of the one or more guide members comprises a cross-sectional area in a plane defined by the first neutral axis and the second neutral axis, and a centroid of the cross-sectional areas is offset from each of the first neutral axis and the second neutral axis.

23. A method according to claim 21 wherein each of the one or more guide members are fixedly attached at a location on a surface of the support that is not intersected by either of the first neutral axis or the second neutral axis.

24. A method according to claim 21 wherein at least one of the one or more thermal compensation members is separated from the at least one of the one or more guide members by each of the first neutral axis and the second neutral axis.

25. A method according to claim 21 wherein the one or more thermal compensation members comprise a plurality of thermal compensation members, and each thermal compensation member of the plurality of thermal compensation members is fixedly attached to a different surface of the support.

26. A method according to claim 21 wherein each of the first neutral axis and the second neutral axis is substantially perpendicular to a rotational axis of the imaging drum.

27. A method according to claim 21 comprising fixedly attaching each of the one or more thermal compensation members to the support to reduce a positional error associated with a focal point of at least one of the imaging beams directed towards the imaging drum.
